(19) United States
(12) Patent Application Publication
(10) Pub. No.: US 2004/0010958 A1
(43) Pub. Date: Jan. 22, 2004

(54) Method and electronic acoustic fish attractor

(76) Inventors: Leonid Pavlov, Port Colborne (CA); Yuliya Rozhko, Port Colborne (CA); Albert Yelizarov, Minsk (RU)

Correspondence Address: Leonid Pavlov, 173 ASH ST., Port Colborne, ON, L3K 2W7, CA

(21) Appl. No.: 10/618,222

(22) Filed: Jul. 14, 2003

Related U.S. Application Data
(60) Provisional application No. 60/396,995, filed on Jul. 22, 2002.

(51) Int. Cl. A01K 69/00

(52) U.S. Cl. 43/17.1; 43/4.5

(57) ABSTRACT

The present invention relates to a method and an electronic acoustic fish attractor for attracting fish to a desired location. The method comprises multi-step transmitting of attracting sounds from that location on the outside on various distances into a body of water. There are optimum energy datum points at distances from a source of a sound. SL₁<SL₂<SL₃< . . . <SLₙ₋₂<SL_{n-1<SL}ₙ. SL₁=I₁, where I₁ is intensity of a sound source at the first step of transmitting a sound. It includes the maximum excess of a hearing threshold of a fish at which it is not frightened off. I′₁ includes the minimum excess of a hearing threshold of fish, which provides an enough active audibility at fish. The natural drop between I₁ and I′₁ at the first step occurs on very short distance from a source of a sound. At each subsequent step the precisely certain values I₁ and I′₁ are reached on the greater distances, which can reach several kilometers. Thus, on distances d₂-d₁, d₃-d₂, . . . , dₙ₋₁-dₙ₋₂, dₙ-dₙ₋₁ the conservation of values I₁ and I′₁ is possible.

### BACKGROUND OF THE INVENTION

1. Field of the Invention

The present invention relates to system and method for eliciting a behavioral response in fish by means of acoustic and vibration stimuli transmitted stepwise. More particularly, the invention relates to system and method which uses characteristics of animal sounds and vibrations more efficiently and easily create underwater sounds and vibrations for attracting the fishes from large distances and which may incorporate primary behavior sounds and vibrations of native aquatic animals in a particular underwater area in which attracting fish is desired. For the purpose of attracting fish, the invention may be useful in the amateur, sports and commercial fishing.

2. Description of the Related Art

Fish use sound and acoustical sensor to adapt to their environment. Much work has been done to identify and qualify the marine acoustical environment. Bioacoustics of whales, dolphins and sharks has studied enough deeply. The relationship that fishes have with sound is less understood. Information on bioacoustics of the freshwater fish in most cases is absent. To the best of our knowledge, no one has yet measured the hearing or vibration-detecting capabilities of walleye, bass, muskellunge, pike, perch etc.

Scientific as well as not so scientific references should be understood as pointers in direction of possible research, not as exhaustive sources of information. Lots of interesting stuff, lots of garbage.

Heretofore the study of sound perception in fish has divided this class of animal into two “camps”: those that are “sound specialists” and those that are “sound generalists”. Some of the distinctions between these groups arise around whether the fish has a method of producing sound, and how complex their known organs of sound perception are. These qualifications have served as general guidelines for the inquiry, but one question that has kept the door open for further exploration—and the erosion of the distinction—is “why do sound generalists need to have a relationship with sound anyway?” As a result, the “specialist/generalist” distinction is rapidly becoming obsolete as we learn some of the ways a various fish use sound in their environment.

Perhaps most intriguing to this is the recent consideration that ambient noise in the ocean may actually serve as a source of “acoustical illumination”, similar how daylight illuminates objects we see. The theory is that objects and features in water cast acoustic shadows and reflections of ambient noise that fish can perceive and integrate into their perception of their surroundings. [Potter J. R. & Chitre M. A. “Ambient noise imaging in warm shallow seas; second-order moment & model-based imaging algorithms”, JASA 106(6), 1999; Peter H. Rogers “What are fish listening to?”, JASA Suppl. 1, Vol. 79, 1986]. This has far reaching implications for the distinction of how fish use sound in the sea, and muddies up the distinction between sound specialist and sound generalist groups.

There are some common attributes in fish adaptations to various environments. Fish that live in estuaries or muddy environments often have some clear methods to perceive that environment. This often includes the ability to produce sound, and mechanical sensors that facilitate the perception of the sound they produce; but fish that do not live in muddy water may also have these sensing organs—even while they don't produce sound. There are organs in some fish that sense pressure and depth that also sense pressure gradient due to acoustical energy. Some fish have sense organs that are extremely sensitive to subtle particle and impulse motion—organs that work even in strong currents while the fish is moving. From a standpoint, their swimming should overload the sensitivity of the organs—from this we could surmise that these fish may have some complex ways of integrating motion stimulus that would be akin to our being able to hear a mouse whisper while driving on the freeway. [J. Engelmann, W. Hanke, J. Mogdans and H. Bleckman “Neurobiology: Hydrodynamic stimuli and the fish lateral line”, Nature, 408, 51-52, 2000].

Hearing capacity of fish is usually expressed as an audiogram, a plot of sensitivity (threshold level in dB SPL) vs. frequency, which is obtained by behavioral or electrophysiological measures of hearing. Fish typically have a U-shaped hearing curve. Sensitivity decreases on either side of a relatively narrow band of frequencies at which hearing is significantly more acute. The decline in sensitivity is generally steepest above the best frequency. Behavioral and neurophysiological hearing curves are generally similar, although behavioral audiograms typically have lower thresholds for peak sensitivities. Most audiograms of fishes indicate a low threshold (higher sensitivity) to sounds within the 20-1000 Hz range.

Probably the most distinct organ associated with fish aside from their gills is an internal swim bladder. This organ serves many functions in fish. In its most basic consideration it serves as a hydrostatic regulator, allowing the fish to mediate buoyancy and equalize internal and external pressure. Because of the physical properties of a swim bladder, its contribution to audition involves pressure gradient sensing. This is both in terms of comparative hydrostatic sensing, as well as more rapid changes or oscillations of pressure gradients—i.e. acoustical energy. This capability would allow fish to sense long distance sound generation and ambient noise by way of this organ. Not all fish have swim bladders; bottom dwelling fish such as walleye or salmon don't have swim bladders

Many fish have a mechanism of small bones called “weberian ossicles” that fasten to the swim bladder and transfer vibrating energy from the bladder to the labyrinth of the inner ear.

All teleost fish have a organ running along the outside length of their bodies and parts of their heads tells fish exactly what is going on in the water around them, even if they can't see it. This organ, called the lateral-line system, consists of numerous hair-like sensors that pick up movement in the water and convert it to the nerve pulses that alert the fish to a nearby predator, or perhaps a tasty meal. But most of the motions in the water are just noise—turbulent currents for instance—and no one has been able to tell how fish knows the difference. Afore-mentioned Dr. Jacob Engelmann and his colleagues at the University of Bonn now think they have figured it out. The lateral-line system has two types of sensory hairs: those on the surface of the fish, called superficial neuromasts, and others that lie within small channels in the fish's skin, called canal neuromasts. “The superficial neuromasts function as velocity receptors, meaning they are sensitive to the velocity between the fish and its surroundings,” says Engelmann. These receptors give fish a sense of movement as they swim and help them orient themselves with the current and stream flow. In running water, the canal neuromasts can detect sudden changes in the water's speed-a telltale sign of a closing predator, or panicking prey the fish wants to catch.

The lateral line is especially sensitive to low-frequency vibrations. “Distinguishing what a fish hears with its inner ears from what it senses as vibrations via the lateral line is a kind of Gordian knot comparable to separating singer and song,” says Dr. R. Aidan Martin. Many fish sensory biologists refer to the combination of inner ears and lateral lines as the acoustico-lateralis system. “Half the vertebrates on the planet are fish and all fish have lateral lines. So if you want to understand how vertebrates work, you have to understand the lateral-line system,” says Jacqueline Webb, professor of biology at Villanova University. The lateral line frequently is named as a fish's sixth sense. Through it, fish can half-feel and half-hear vibrations. Here opinion of the skilled angler on Great Lakers: “At night, most walleye track prey by picking up vibrations with their lateral lines up to 20 feet away,” says Richard Anderson.

Sound is a multi-stage event that requires four components to occur: a source of vibration, a transmitting medium, a receiving detector, and an interpreting nervous system. Sound energy is carried by the oscillation of particles composing a transmitting medium. In the case of fish, the transmitting medium is the water through which they swim.

Decibels Underwater Are Not The Same As Decibels In Air! “Underwater 160 dB” is equivalent to 98 dB in-air. A level of 122 dB in-water is equivalent to 60 dB in-air. This is the level human would hear when having a normal conversation (Cornel Lab., Bioacoustics Research Program).

One of the more popular models used to describe the propagation of sound through water or air is the “source, path, receiver” model (Richardson, 1995). The basic parameters (there are many we will not discuss) in this model:

source: source level (SL);

path or medium: transmission loss (TL);

receiver: sound intensity level (SIL).

A simple model of sound propagation is:

SIL=SL−TL,

where TL=10 log (Intensity at 1 meter/Intensity at r meters away from the source). For our purposes we'll deal only with spreading (TL_{g}) and absorption loss (TLₐ):

TL=TL_{g}+TLₐ,

where

TL_{g}=20 log r; TLₐ=αr,

where α is the attenuation coefficient and a function of frequency.

The rate at which sound is absorbed by water is related to the square of frequency (α∞f²); lower frequency sounds have low absorption coefficients and therefore propagate long distances. If you know the frequency of the sound you're dealing with, the attenuation coefficient (α) can be looked up in the appropriate table or graph in any acoustic textbook

The fishes can swim on two speeds: with a burst swimming speed (a maximum swimming speed which can be maintained for less than a minute only) and with a sustained speed (swimming at this speed for a prolonged time). The FishBASE Tables contain information at sustained and burst speeds for different species of fish. The information was extracted from over 50 references such as Bainbridge (1958, 1960), and Welb (1971) and compilations such as Sambilay (1990). The Speed Table consists of the following fields: Length: This field pertains to the length of fish in centimeters as stated SL (Standard Length); FL (Fork Length); TL (Total Length); BL (for the term “body length”, stated in the publication but without the type of length measurement being indicated).

There are no the prototype patents. Only an indirect connection is with the U.S. Pat. No. 4,646,276 to J. J. Kowalewski et al. (dated Feb. 24, 1987); U.S. Pat. No. 4,955,005 to P. H. Loeffelman (dated Sep. 4, 1990); U.S. Pat. No. 5,883,858 to S. P. Holt (dated Mar. 16, 1999).

A main principal limitation of these and other similar thematic patents is the absence of the solution how to create an electronic acoustic fish attractor effectively working on admissible distances , which can satisfy requirements of the consumers.

A review of more than 1000 patents and of the available literature shows that such situation has formed because of an extraordinary complication to develop the methods and devices with all necessary characteristics, which simultaneously satisfy the requirements of environmental conditions. It involves lots of biological, acoustic, electronic, electrical and mechanical considerations. This unusual junction of sciences with the added concern about cost, makes a solution of task extremely complicated.

### SUMMARY OF THE INVENTION

The mentioned above problems of the prior art are overcome in accordance with the present invention by the multi-step transmission of sounds. The invented method and system allow at each subsequent step to expand a zone of search of fishes.

For example, Table 1 shows data of hearing thresholds of Cod , Salmo Salar (Atlantic salmon), Euthynnus (is a tuna without a swimming bladder), obtained by a number of laboratories (Popper Lab. Home page; A. N. Popper et. Al., Nature, 1997, 389:341; J. Acoust. Soc. Am., 104: 562-568), and also Maximum and Minimum Permissible excesses of hearing thresholds offered by us.

TABLE 1
The Initial Data for an elaboration of mathematical models of the
multi-step transmission of sounds, as an example

| | | | Permissible excesses of | |
|---|---|---|---|---|
| | | Hearing | hearing threshold, | |
| | Frequency | threshold | dB re: 1 μPa | |
| Species of fish | Hz | dB re: 1 μPa | Maximum | Minimum |
| Cod | 180 | 67 | 28 | 18 |
| Atlantic Salmon | 180 | 89 | 31 | 21 |
| Tuna | 500 | 107 | 33 | 23 |

In accordance with this invention, an electronic acoustic fish attractor includes an acoustical underwater low frequency multi-pick omnidirectional transducer, and electronic circuitry for providing audio-on-demand (AOD) services, and a source for power feed. There are means of distributed acoustic active feedbacks in an electronic circuitry of transmission of sounds. Such system allows to attract different species of fish broadcasting sounds natural for these species.

### BRIEF DESCRIPTION OF THE DRAWINGS

A detailed description of the preferred embodiments is provided herein below with reference to the following drawings, and which:

FIG. 1 is a diagram showing the method steps of the devised system and method for attracting fishes.

FIG. 2 is a diagram showing the method steps of the devised system and method, for example, for attracting Cod with a hearing threshold of 67 dB re: 1 μPa.

FIG. 3 is a diagram showing the method steps of the devised system and method, for example, for attracting Atlantic Salmon with a hearing threshold of 89 dB re: 1 μPa.

FIG. 4 is a diagram showing the method steps of the devised system and method, for example, for attracting Tuna with a hearing threshold of 107 dB re: 1 μPa.

In the drawings, preferred embodiments of the invention are illustrated by the way of example. It is to be expressly understood that the description and drawings are only for the purpose of illustration and as an aid to understanding, and are not intended as a definition of the limits of the invention.

### DETAILED DESCRIPTION OF THE INVENTION

As an example in the Table 1 is given the initial data for an elaboration of the mathematical models of the multi-step transmitting sounds for attraction of the fishes specified in this table . All intensities of a sound are calculated concerning the location of a source of a sound, in which the fish should be attracted. The difference between maximum and minimum excesses of a hearing threshold of a fish is inevitable at transmitting a sound signal. It is the basis at the first step of transmitting a sound and this difference should be constant on the every segment of increasing distance at all subsequent steps of transmitting a sound. The minimum excess of a hearing threshold should provide an enough active audibility in fishes. The maximum excess of a hearing threshold should provide critical loudness of a sound, at which the fish is not frightened off.

We have devised system and method of multi-step transmitting a sound. The analysis of the calculated data of attenuation of a sound intensity with distance has shown that there are the optimum energy datum marks at distances from a source of a sound, for example, 5 m, 16 m, 50 m, 160 m, 500 m, 1600 m etc. The losses of a sound intensity on these distances from a transducer accordingly approximately are equal (dB re: 1 μPa): 14 dB, 24 dB, 34 dB, 44 dB, 54 dB, 64 dB. Under the certain conditions, the constant primary values of maximum and minimum excesses of a hearing threshold are supported between these points. A large amount of acoustic feedbacks are applied in the circuitry of transmission of a sound. It allows to construct the diagrams of multi-step transmission a sound for any kind of fish.

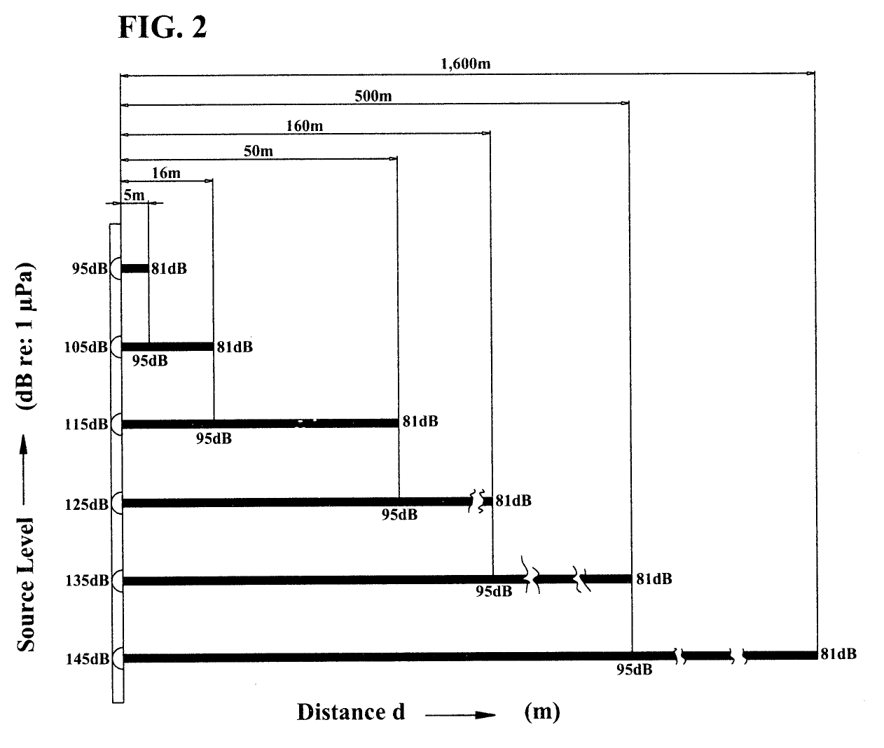

FIGS. 2-4 are diagrams showing the multi-step transmission sounds for attracting the fish specified in the table 1.

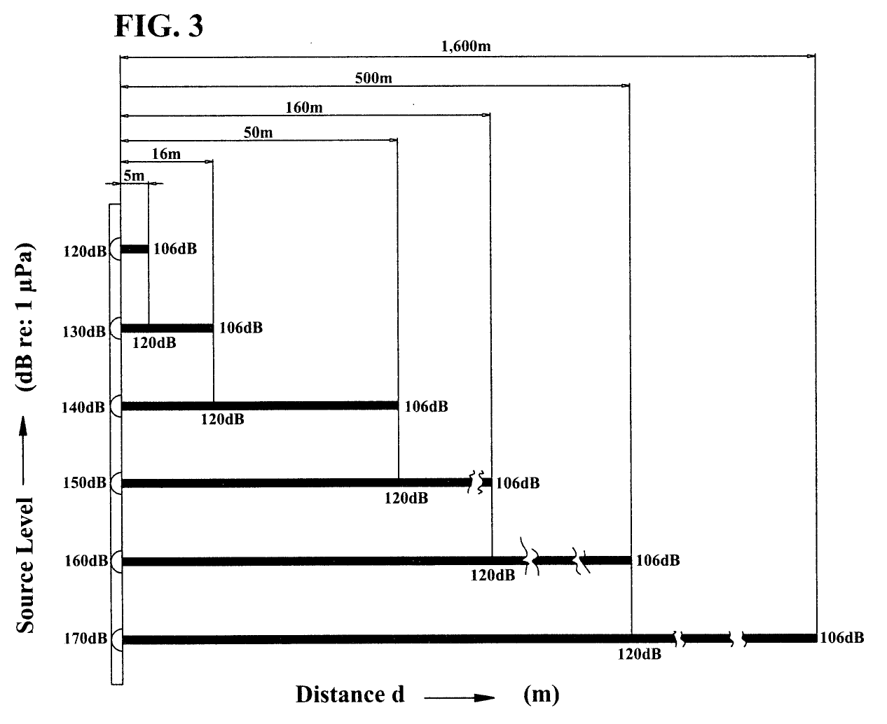

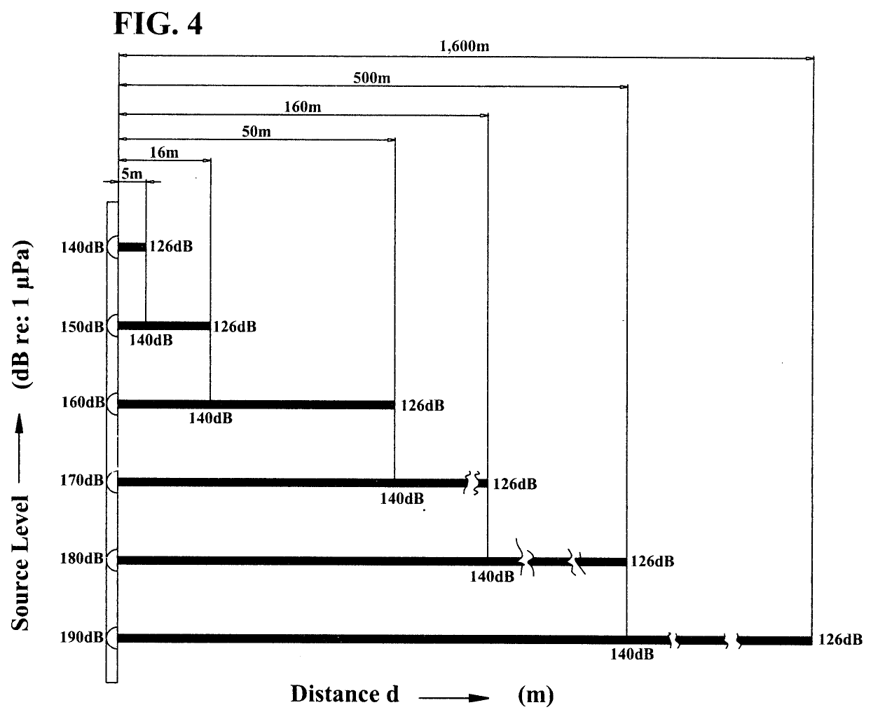

Use of fish attractors with a sound intensity more than 160 dB re: 1 μPa at amateur and sports fishing will cause the serious complication with defense counsels of an environment. Such restriction of a sound intensity does to inexpedient an application of our fish attractor for catching Tuna (see FIG. 4) in above named kinds of fishing. Next, Atlantic Salmon (see FIG. 3), a hearing threshold is equal to 89 dB. Effective radius of action of a fish attractor in this case is limited 500 m. It is much more effective, than today's catching salmons, trout, basses, walleyes etc. from the large boats by trolling. Next, Cod (see FIG. 2), a hearing threshold is equal to 67 dB. The devised method of multi-step transmission of attracting sounds (signals) is effective for fish with such hearing threshold on distances in some kilometers. Therefore, from our point of view, it is necessary to enter the second restriction for amateur and sports fishing: the overall performance of fish attractors should not exceed 500 m.

How the time intervals of each step are defined? The speed of sound in water is approximately 1,500 m/s. An attracting signal will reach fish, located on distance 1,000 m, for 0.67 seconds, and fish, located on distance 100 m, practically instantly. The fish will start swimming, obviously, with a burst swimming speed. Distance is large. One minute has passed. Then the fish passes to a mode of a sustained speed. A significant interval of a modulation at every step of multi-step transmission a sound is calculated elementarily: τ=d:v, where τ is necessary time of broadcasting, (s); d is length of zone, (m), and v is swimming speed of fish, (m/s).

### FOR EXAMPLES

Atlantic Cod : 200.0 cm TL, a burst speed is 2.0 m/s and a sustained speed is 0.2 m/s;

Atlantic Salmon: 100,0 cm TL, a burst speed is 1.0 m/s and a sustained speed is 0.11 m/s.

Now, there are all data to calculate necessary time of broadcasting attracting signal for each step of the appropriate mathematical model of multi-step transmission of sounds.

Atlantic Cod:

Step I: Site of Sound Source—distance 5 m. Time limit is not established.

Step II: Increasing distance is equal: (16 m−5 m)=11 m. The time interval is equal: 11 m: 2.0 m/s=5.5 s.

Step III: Increasing distance is equal:(50 m−16 m)=34 m. The time interval is equal: 34 m: 2.0 m/s=15.0 s.

Step IY: Increasing distance is equal: (160 m−50 m)=90 m. The time interval is equal: 90 m :2.0 m/s=45.0 s;

Step Y: Increasing distance is equal: (500 m−160 m)=340 m; The time interval is equal to time of swimming with a burst speed (during 60 s) plus time of swimming with a sustained speed:

a) 2.0 m/s×60.0 s=120 m;

b) (340 m−120 m): 0.2 m/s=1,100.0 s

c) Στ=60.0 s+1,100.0 s=1,160.0 s=19 min 20 s.

Total time on steps II-Y is equal: Στ=5.5 s+15.0 s+45.0 s+1.160 s=1,225.5 s=20 min 25.5 s.

Atlantic Salmon:

Step I: Site of Sound Source—distance 5 m. Time limit is not established.

Step II: Increasing distance is equal: (16 m−5 m)=11 m. The time interval is equal: 11 m:1.0 m/s=11.0 s.

Step III: Increasing distance is equal: (50 m−16 m)=34 m. The time interval is equal: 34 m: 1.0 m/s=34.0 s.

Step IY: Increasing distance is equal: (160 m−50 m)=110 m. The time interval is equal to time of swimming with a burst speed (during 60 s) plus time of swimming with a sustained speed:

a) 1.0 m/s×60.0 s=60 m;

b) (110 m−60 m): 0.11 m/s=454 s;

The total time on step IY is equal: Στ=60 s+454 s=514 s .

Step Y: Increasing distance is equal: (500 m−160 m)=340 m. The time interval is equal to time of swimming with a burst speed (during 60s) plus time of swimming with a sustained speed:

a) 1.0 m/s×60.0 s=60 m;

b) (340 m−60 m): 0.11 m/s=2545 s;

Total time on step Y is equal: Στ=60.0 s+2545 s=2,605 s.

Total time on steps II-Y is equal: Στ=11 s+34 s+514 s+2,605 s=3,164 s=52 min 44 s

It is obvious, that on “Step I” there is a free choice of time, as it has the Permissible excess of a hearing threshold on all distance.

For example, the following sequence is possible in steps for attracting Atlantic Salmon:

“Step I” is turned on for 2-3 minutes. If a bite began, to continue to fish in this mode. If a bite is absent, then:

“Step II” is turned on. “Step II” will be switched over automatically on “Step I” after the expiration 11 seconds. If a bite began, to continue to fish in this mode. If a bite is absent, then

“Step III” is turned on. “Step III” will be switched over automatically on “Step II” after the expiration 34 seconds, and “Step II” will be switched over automatically on “Step I” after the expiration 11 seconds. If a bite began, to continue to fish in this mode. If a bite is absent, then:

“Step IY” is turned on. “Step IY” will be switched over automatically on “Step III” after the expiration 514 seconds; “Step III” will be switched over automatically on “Step II” after the expiration 34 seconds, and “Step II” will be switched over automatically on “Step I” after the expiration 11 seconds. If a bite began, to continue to fish in this mode. If a bite is absent, then:

“Step Y” is turned on. “Step Y” will be switched over automatically on “Step IY” after the expiration 2,605 seconds; “Step IY” will be switched over automatically on “Step III” after the expiration 514 seconds; “Step III” will be switched over automatically on “Step II” after the expiration 34 seconds, and “Step II” will be switched over automatically on “Step I” after the expiration 11 seconds.

Multiple recurrences of turns-on are possible on any step of transmission of a sound.

Time intervals for other kinds of fishes are calculated analogously.

Number of steps and their running cycle can differ depending on hearing thresholds of particular kinds of fishes, conditions of reservoirs and a way of fishing (stationary, trolling etc.). Hence, method and specified system can be easily used as means for attracting various kinds of fishes from the very large distances never before possible.

Obviously, when all opportunities of a fish-attractor are exhausted, and the bite did not begin, it is necessary to replace a place on a reservoir and to try to catch other kinds of fishes. In this case, a fish-attractor should work on the appropriate channel for other particular kind of fishes.

The number of steps of transmitting sounds can be continued for commercial fishing by special boats having a powerful feed and appropriate transducers. For example, the attraction of salmon is possible from distances of 1.6 km, 5.0 km and 15.0 km at the appropriate number of steps and maximum intensity of sound (dB re 1 μPa): 6/170, 7/180, 8/190.

Unfortunately, acoustic underwater low-frequency multi-peak omnidirectional transducers (the sound projectors) absolutely are absent in the world. The contacts with all key manufactures and elaborators of underwater low frequency transducers were established. Nobody has undertaken to develop necessary to us the multi-peak transducer capable of producing a significant amplitude or shock wave component of the sound in pulsing conditions generated to elicit a behavioural response in specific fish. It was our indispensable condition.

Now, the broadened staff of the co-authors of the given invention has practically solved the given problem. The patent application on such transducer will be sent in near future.

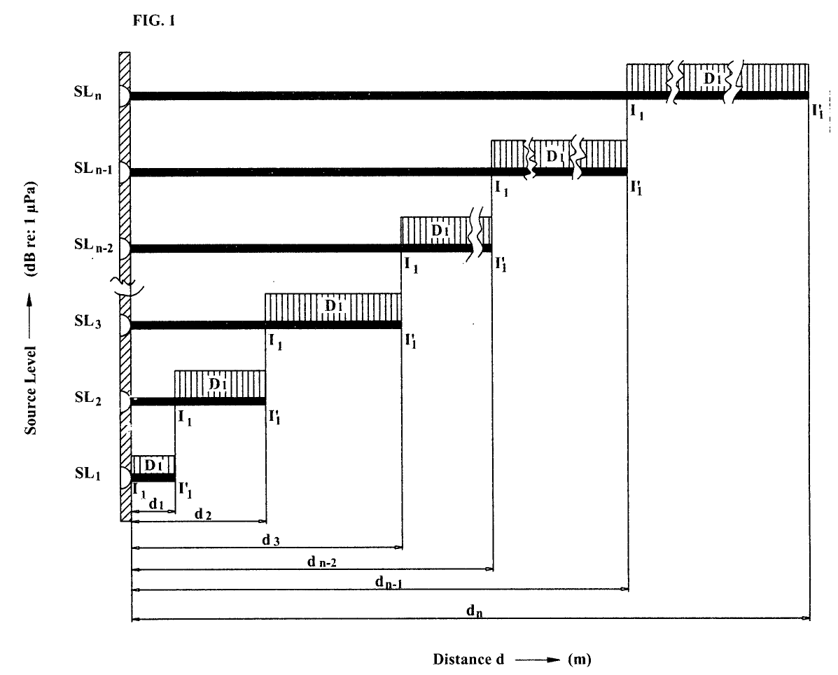

Generalizing the given examples we have (see FIG. 1): SL₁<SL₂<SL₃< . . . <SLₙ₂<SLₙ₋₁<SLₙ. SL₁=I₁, where I₁ is intensity of a sound source at the first step of transmission of a sound. It includes the maximum excess of a hearing threshold of a fish, at which it is not frightened off. I′₁ includes the minimum excess of a hearing threshold of a fish, which provides an enough active audibility at a fish. The natural drop between I₁ and I′₁ at the first step occurs on very short distance from a source of a sound. At each subsequent step the precisely certain values I₁ and I′₁ are reached on the greater distances, which can reach several kilometers. Thus, on distances d₂-d₁, d₃-d₂, . . . dₙ₋ₗ-dₙ₋₂, dₙ-dₙ₋₁ the conservation of values I₁ and I′₁ is possible.

Although preferred embodiments have been describe herein in detail, it is understood by those skilled in the art that variations may be made thereto without departing from the scope of the invention or the spirit of the appended claims.

The embodiments of the invention in which an exclusive property or privilege is claimed are defined as follows:

1. A method for acoustic attracting fish to a desired location, said method comprising: multi-step transmission of attracting sounds from that location on the outside on various distances into a body of water.

2. The method defined in claim 1 and further is characterized as including the steps of: an establishment of admissible values of maximum and minimum excesses of hearing thresholds of fish, and an establishment of the optimum energy datum points at distances from a source of a sound, and supporting the constant primary values of maximum and minimum excesses of a hearing threshold of fish on the every segment of increasing distance between these energy datum points at each two consecutive steps of transmitting a sound with simultaneous increase of an intensity of a sound from a transducer at each subsequent step of transmitting a sound, and calculating a necessary time for swimming by a fish of distances between the specified energy datum points, as functions of these distances and speeds of swimming particular kinds of fish.

3. The method defined in claim 2 wherein on every subsequent (after first) step of transmitting a sound there is an automatic transition on back through all previous steps in a mode of transmitting a sound at a step I, thus, that at each step the necessary calculated time is kept.

4. The method defined in claim 2 wherein the every subsequent step of transmitting a said sound is an expansion of the searching area—attracting fish.

5. The method defined in claim 2 wherein the multiple recurrences of transmitting a sound are possible at any step of its transmission.

6. The method defined in claim 1 wherein the transmitted attracting sounds are the preliminary recording of the behavior sounds of smaller live baits with same or close to power spectra of radiated signals by the concrete species of attracted fish and allowable factor of nonlinear distortions in a radiated band of frequencies and by frequency.

7. The method defined in claim 1 wherein the transmitted sounds are broadcasted with a significant amplitude or shock wave component of a sound in a pulsing operation.

8. An electronic acoustic fish attractor comprising: a system for providing audio-on-demand (AOD) services, an underwater multi-peak omnidirectional sound projector and power source.

9. The electronic acoustic fish attractor defined in claim 8, wherein the system for providing the AOD services further comprises: the AOD server in which is stored predetermined content; each data item in the data set comprises one or more sections, and the totality of sections constitutes the complete data set; individual data items within the set can be accessed for playback; and active acoustic distributed feedback means in a circuit of a cyclic transmission of sounds.

10. The electronic acoustic fish attractor defined in claim 8, wherein the underwater multi-peak omnidirectional sound projector is supported with a ball (load) of a downrigger or it realizes an additional function as a ball (load) at fishing by trolling or stationarily.
